(19) United States
(12) Patent Application Publication
(10) Pub. No.: US 2006/0277058 A1
(43) Pub. Date: Dec. 7, 2006

(54) Method and apparatus for providing aftermarket service for a product

(76) Inventors: Jack Ivan J'maev, Chino, CA (US); Addison Brooke Jones, Yorba Linda, CA (US); Tzvetelin Petrov Petrov, Chino, CA (US)

Correspondence Address: INTELLECTUAL PROPERTY DEVELOPMENT;JACK IVAN J'MAEV, 14175 TELEPHONE AVE., SUITE L, CHINO, CA, 91710, US

(21) Appl. No.: 11/347,673

(22) Filed: Feb. 3, 2006

Related U.S. Application Data
(63) Continuation-in-part of application No. 10/615,412, filed on Jul. 7, 2003.
(63) Continuation-in-part of application No. 10/850,476, filed on May 19, 2004.
(60) Provisional application No. 60/650,436, filed on Feb. 4, 2005.

(51) Int. Cl. G06Q 99/00

(52) U.S. Cl. 705/1

(57) ABSTRACT

Disclosed are a method and various embodiments thereof for providing aftermarket service for a product. The method and its various embodiments are used to provide aftermarket service by receiving a user response by means of a communications channel. The communications channel is configured according to a contact identifier, which is included on a product. The contact identifier is included on a product in association with a product notice receiver that is integrated in the product. Upon receipt of a user response, the user response is serviced.

### RELATED APPLICATIONS

This present application is a continuation-in-part of application Ser. No. 10/615,412 filed on Jul. 7, 2003, entitled “Method and Apparatus for Receiving Product Notices”, by J'maev, currently pending, for which the priority date for this application is hereby claimed and which is hereby incorporated by reference herein in its entirety; this application is also a continuation-in-part of application Ser. No. 10/850,476 filed on May 19, 2004 also by J'maev entitled “Method and Apparatus for Product-Centric Delivery of Product Notices”; this application claims priority to provisional application 60/650,436 filed on Feb. 4, 2005 by J'maev entitled “Method and Apparatus for Providing Aftermarket Service for a Product”.

### BACKGROUND

As discussed in the referenced application which is integrated herein, contacting product users has historically been accomplished using a user database. The user database is generally compiled as product users register their ownership of a particular product. It can be appreciated that the product registration process is ineffective because product owners seldom engage in the registration process.

Product registration has long been accomplished through the use of a product registration postcard. In the ideal world, every new owner of a product would fill out the registration postcard and mail it back to a product manufacturer or in many cases to a third-party fulfillment company. The manufacturer or the fulfillment company would then compile a database using the returned postcards. The database can include any type of user identifier. For example, a user is often asked to provide a name, a mailing address, an electronic mail address and a telephone number when registering. In the event that a product recall or other type of notice needs to be conveyed to the users of a product, the database is used to direct product notices to all of the registered users reflected therein. Up until now, the preferred mechanism for directing a product notice to a user was through the mail, electronic mail or by telephone.

In reality, only about 15% of product users actually fill out a product registration postcard. So, when a recall or other product notice needs to be conveyed to the users of a particular product, very few of the actual and current users of the product are actually notified. Also, whenever a product changes hands, e.g. when a baby car seat is sold at a garage sale, the registered owner identified in the database is no longer the actual and current user. There is even less likelihood that either the original or the new owner will register the change of ownership of a particular product.

The federal government is encouraging the use of electronic product registration. For example, many fulfillment companies and manufacturers are now using Internet technology (i.e. through the World Wide Web) to receive product registration information. By using the Internet, product registration is typically increased to about 30%. This, though, is expected to be a novel and short term reaction of the public to this modern product registration method. It again comes down to the fact that users are simply not willing to spend one iota of time in filling out a registration form, irrespective of the type of form—paper or web page.

A fulfillment company is motivated to service user responses when an actual product notice is issued. Generally, the fulfillment company is compensated by a manufacturer based on the number of notices that are issued (which is driven by the number of registered users in the database) and the number of user responses that it services. As a result of the low registration rate that confounds the product notification industry, manufacturers fall far short of 100% notification. Fulfillment companies loose valuable revenue based solely on the fact that they are only able to contact and optionally service no more than 15 to 30% of the product users that actually need to be contacted and made aware of a product hazard.

### SUMMARY

Disclosed are a method and various embodiments thereof for providing aftermarket service for a product. The method and its various embodiments are used to provide aftermarket service by receiving a user response by means of a communications channel. The communications channel is configured according to a contact identifier, which is included on a product. The contact identifier is included on a product in association with a product notice receiver that is integrated in the product. Upon receipt of a user response, the user response is serviced.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow of diagram that depicts one example method for providing aftermarket product service; FIG. 2 is a flow diagram that depicts alternative methods for configuring a communications channel according to a contact identifier;

FIG. 3 is a flow diagram that depicts yet another illustrative method for providing aftermarket service for a product;

FIGS. 4 and 5 are flow diagrams that depict alternative methods for receiving a request for a product service action;

FIGS. 6 and 7 collectively constitute a flow diagram that depicts several illustrative alternative methods for receiving a user response by means of a data network;

FIG. 8 is a flow diagram that depicts alternative example methods for receiving a user response by means of a telephone call;

FIG. 9 is a flow diagram that depicts one alternative method for servicing a user response received by means of a data network;

FIG. 10 is a flow diagram that depicts yet another alternative example method for servicing a user response received by means of a telephone channel;

FIG. 11 is a flow diagram that depicts an alternative example method for servicing a user response with an optional dispatch of a product upgrade kit;

FIG. 12 is a block diagram that depicts several example embodiments of a product servicing apparatus;

FIG. 13 is a pictorial diagram that depicts several example embodiments of a request table;

FIG. 14 is a pictorial representation that depicts several alternative embodiments of a response table;

FIG. 15 is a pictorial representation that depicts several alternative embodiments of a user response web page;

FIG. 16 is a pictorial diagram that depicts several example embodiments of a service description web page;

FIG. 17 is a data flow diagram that depicts the internal operation of several alternative embodiments of a product servicing apparatus.

### DETAILED DESCRIPTION

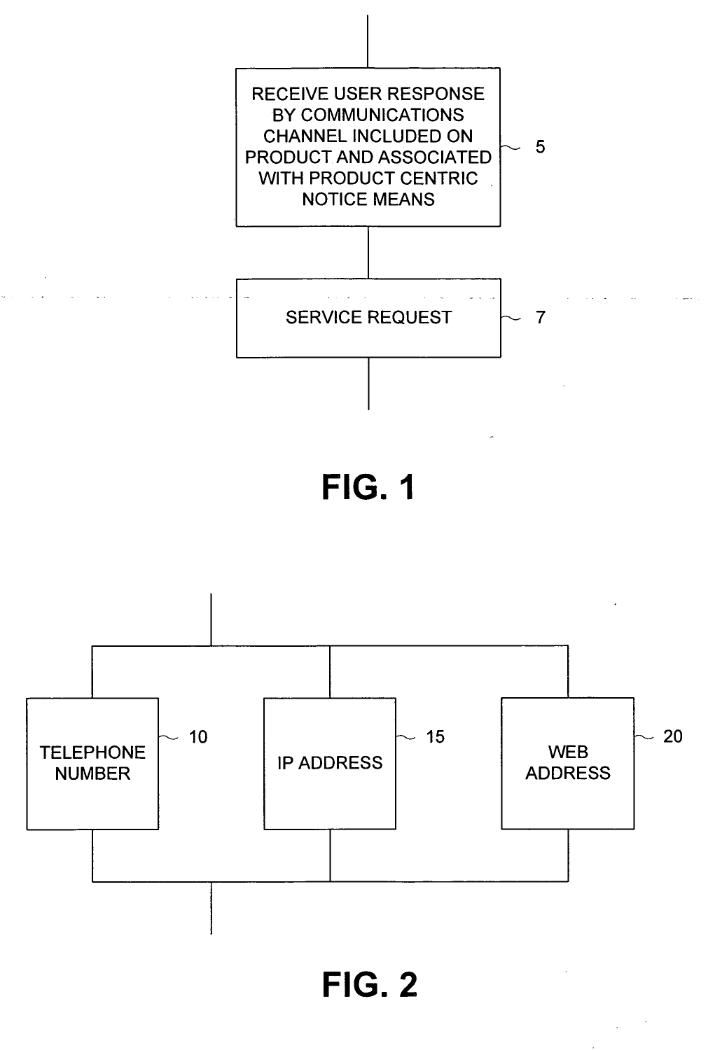

FIG. 1 is a flow of diagram that depicts one example method for providing aftermarket product service. In the application cited above and which integrated herein by reference in its entirety, Applicant J'maev has described a method and apparatus for issuing product notices and a method and apparatus for receiving product notices. It should also be appreciated that, according to the referenced application, a product notice is directed to a product, rather than to a user. As such, a product produced by a manufacturer will include a device known as a product notice receiver (PNR).

In one illustrative method, aftermarket service of a product is provided by receiving a user response (step 5). Such response, according to this variation of the present method, is received by means of a communication channel that is configured according to a contact identifier that is included in the product and which is associated with a product notice receiver included in the product. After the user response is received, a service request is processed (step 7).

FIG. 2 is a flow diagram that depicts alternative methods for configuring a communications channel according to a contact identifier. According to various example variation of the present method, a contact identifier comprises at least one of a telephone number (step 10), an Internet protocol address (step 15) and a logical Web address (step 20).

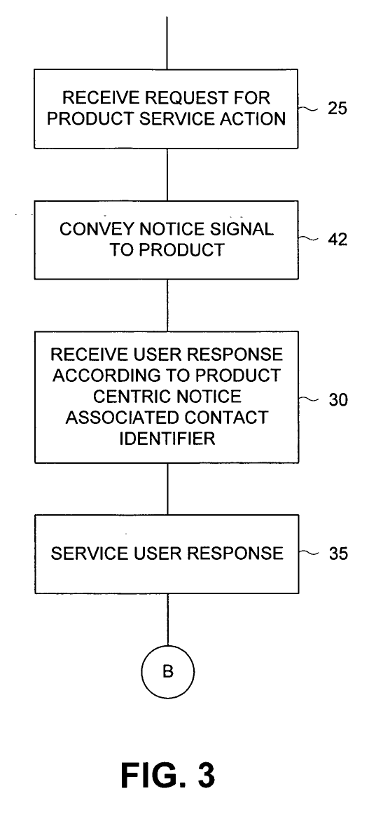

FIG. 3 is a flow diagram that depicts yet another illustrative method for providing aftermarket service for a product. According to this alternative illustrative method, aftermarket service for a product is provided by receiving a request for a product service action (step 25). A user response is then received (step 30) and serviced (step 35). According to this illustrative method, the user response is received according to a contact identifier that is associated with a product centric notice reception means (e.g. a product notice receiver). Typically, a communications channel for receiving a user response is configured according to this contact identifier. Furthermore, according to one variation of the present method, the product centric notice receiving means is typically associated with a product by integrating (or including) the receiving means into a product for which aftermarket service is to be provided. According to one variation of the present method, a signal is dispatched to a product notice receiver according to a received request for a product service action, for example by means of a received product notice receiver target identifier (step 42). Such notice is optionally dispatched to a product notice receiver included in a product in order to inform a user that a user response is required on behalf of the user.

As can be appreciated from the study of the reference integrated herein, a product that includes a product centric notification means typically includes a product notice receiver that typically receives a product notice signal. Associated with the product notice receiver, as heretofore taught by the Applicant, is indicia, wherein the indicia provides a user with instructions for determining additional information about a product notice received by the product notice receiver. For example, in one embodiment of a product that includes a product notice receiver, the indicia include a telephone number. In yet another embodiment, the indicia include a logical Web address. In yet another embodiment, the indicia include an Internet protocol address.

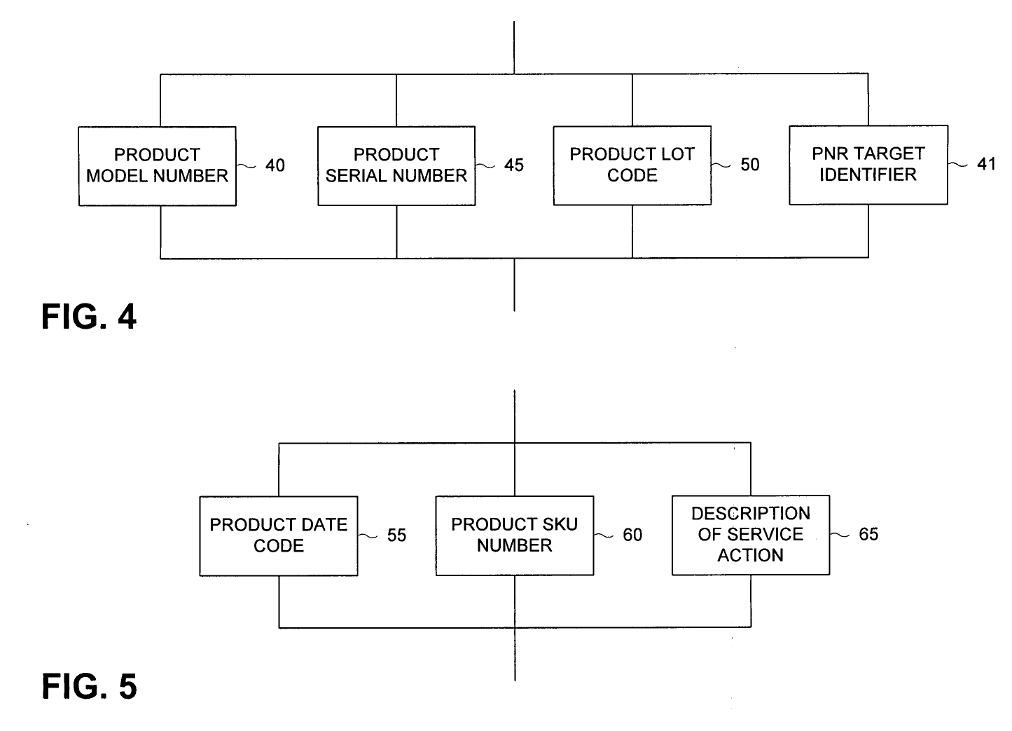

FIGS. 4 and 5 are flow diagrams that depict alternative methods for receiving a request for a product service action. According to one alternative method, a request for a product service action is received by receiving a product notice receiver target identifier (step 41). A product notice receiver target identifier comprises a digital number that is programmed into a product notice receiver in order to enable the product notice receiver to receive a product notice according to said product notice receiver target identifier. Further information with respect to the product notice receiver target identifier is provided in the reference incorporated herein.

According to yet another alternative method, a request for a product service action is received by receiving a product model number (step 40). In yet another illustrative example method, a request for a product service action is received by receiving a product serial number (step 45). In yet another illustrative variation of the present method, a request for a product service action is received by receiving a product lot code (step 50). And in yet another illustrative variation of the present method, a request for a product service action is received by receiving a product date code (step 55). In an alternative variation of the present method, a request for a product service action is received by receiving a product stock keeping unit number (step 60). And in yet another variation of the present method, a request for a product service action comprises receiving a description of the service action (step 65). All of these terms are to be read in light of the prior applications integrated herein.

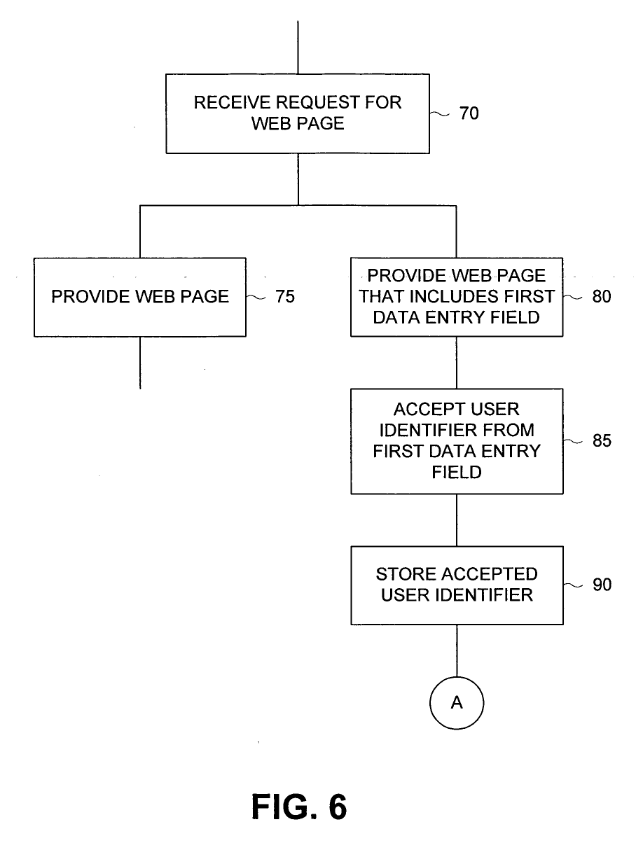

FIGS. 6 and 7 collectively constitute a flow diagram that depicts several illustrative alternative methods for receiving a user response by means of a data network. According to these alternative methods, a communications channel for receiving a user response is configured according to a contact identifier that includes at least one of a web page address and an Internet protocol address. As such, a user response is received in the form of a request for a web page (step 70). According to one alternative variation of the present method, a communications channel for receiving a user response is configured in a manner so as to imply a particular product. Accordingly, a web page is provided (step 75). The web page provided in this variation of the present method will correspond to the implicit product identification provided by particular web page address or Internet protocol address.

According to yet another variation of the present method, the request for a web page does not provide any implicit product identification. As such, a web page is provided in response to the request for a web page, wherein the provided web page includes a second data entry field (step 95). According to this variation of the present method, a product identifier is accepted from the second data entry field (step 100). Additional information can then be provided to the user according to the accepted product identifier. The accepted product identifier, according to one variation of the present method, comprises at least one of a product notice receiver target identifier, a product model number, a product serial number, a product lot code, a product date code, and a product stock keeping unit number. It should be appreciated that additional information, according to one variation of the present method, is provided to the user by selecting an additional data web page that includes a description of remedial action that should be undertaken by the user. This additional web page is to be provided to a client device according to and once a product identifier is accepted from the second data entry field.

According to yet another variation of the present method, a web page is provided in response to a request for a web page, wherein the web page includes a first data entry field (step 80). According to this variation of the present method, a user identifier is accepted from the first data entry field (step 85). The accepted user identifier is then stored (step 90). According to one illustrative use case, it may be desirous to store a user identifier in order to provide evidence that a particular user was notified and subsequently responded to the notification. For example, when a product notice receiver is activated and a user uses the Internet to assess a web page according to a contact identifier associated with the product notice receiver included in the product, the fact that the user was provided additional information by means of a web page can be used to mitigate a manufacturer's exposure to product liability through the use of a stored user identifier. Such evidence can be used to demonstrate that a particular user was properly notified of a product hazard and was provided with additional remedial actions when the user visited a particular web site.

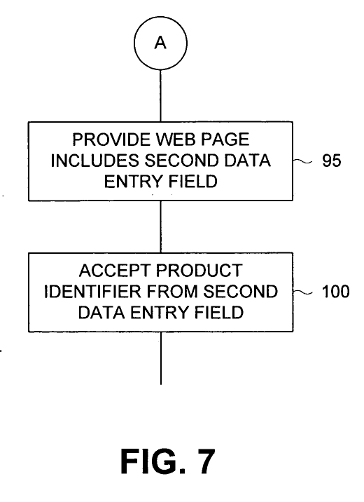

FIG. 8 is a flow diagram that depicts alternative example methods for receiving a user response by means of a telephone call. According to one alternative example method, a communication channel is configured according to a contact identifier which comprises a telephone number. Accordingly, a user response is received as a telephone call by way of a telephone channel (step 105). According to one variation of the present method, a caller identification (i.e. a “Caller-ID”) is received from the telephone channel (step 110). As such, the caller identification is stored (step 115). The caller identification can be used as evidence that a particular user responded to a notification received by product notice receiver included in a product. According to yet another variation of the present method, a product identifier is received from the telephone channel (step 120). A product identifier, according to yet another variation of the present method, is received as one or more touchtone signals which are subsequently decoded into a product identifier. According to yet another variation of the present method, a product identifier is received in a spoken form which is then subsequently converted by a speech recognition process into a product identifier. According to either of these variations of the present method, the product identifier is stored in association with a caller identification received from the telephone channel (step 125). As such, the product identifier associated with a particular caller identification can subsequently be used as evidence that a particular user was notified with respect to a particular product hazard.

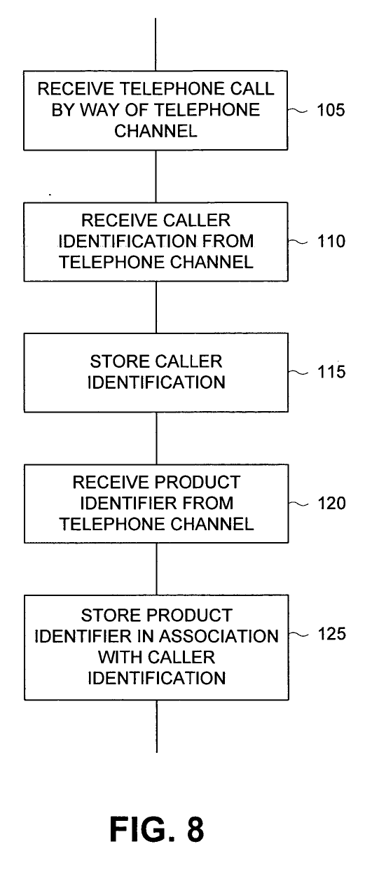

FIG. 9 is a flow diagram that depicts one alternative method for servicing a user response received by means of a data network. According to this alternative example method, a user response is serviced by providing a web page that includes a product identifier data entry field (step 130). A product identifier is then accepted from the data entry field (step 135). According to one variation of this alternative example method, a product identifier comprises at least one of a product notice receiver target identifier, a product model number, a product serial number, a product lot code, a product date code, and a product stock keeping unit number. A description web page is then provided (step 140) according to the accepted product identifier. According to one illustrative use case, a description web page is selected according to an accepted product identifier. Typically, the description web page will include remedial action information for a particular product.

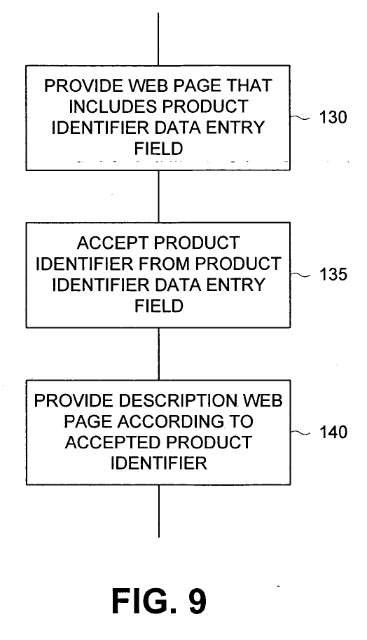

FIG. 10 is a flow diagram that depicts yet another alternative example method for servicing a user response received by means of a telephone channel. According to this alternative method, an audio prompt is directed to a telephone channel (step 145) once an incoming telephone call is received. A product identifier is then received from the telephone channel (step 150). According to one variation of the present method, a product identifier is received as a sequence of one or more touchtone signals, which are subsequently decoded into a product identifier. According to yet another variation of the present method, a product identifier is received as a spoken phrase, which is subsequently subjected to a voice recognition process resulting in a product identifier. A description message is then directed to the telephone channel (step 155), wherein the description is selected according to the product identifier.

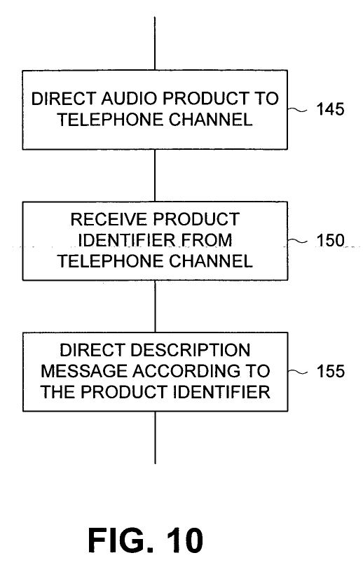

FIG. 11 is a flow diagram that depicts an alternative example method for servicing a user response with an optional dispatch of a product upgrade kit. According to this alternative example method, a user response is serviced by receiving a user identifier (step 160). A user identifier, according to yet another variation of the present method, includes at least one of a user name, a user address, a user city, a user state, a user zip code, a user phone number and a user electronic mail address. Once a user identifier is received, a product upgrade kit is dispatch according to the user identifier (step 165). According to one illustrative use case, a product upgrade kit is directed to a user according to the user's address, the user's city, the user's state and the user's zip code, which collectively comprise a user's mailing address. According to one variation of the present method, the user identifier is received by means of a data connection (e.g. by means of a web-based interface).

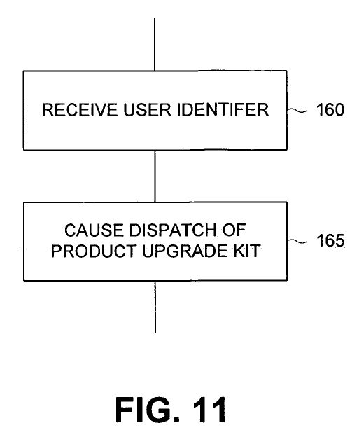

FIG. 12 is a block diagram that depicts several example embodiments of a product servicing apparatus. According to one example embodiments, a product servicing apparatus 201 comprises a processor 200, a request receiver 205, a response receiver 220 and a memory 240. According to one alternative embodiment, a product servicing apparatus 201 further includes a service unit 235. The aforementioned elements are communicatively associated with each other by means of a bus 255.

The various example embodiments of a product servicing apparatus 201 as heretofore described further include various functional modules each of which comprises an instruction sequence that can be executed by the processor. An instruction sequence that implements a functional module, according to one alternative embodiment, is stored in the memory 240. The reader is advised that the term “minimally causes the processor” and variants thereof is intended to serve as an open-ended enumeration of functions performed by the processor as it executes a particular functional module (i.e. instruction sequence). As such, an embodiment where a particular functional module causes the processor to perform functions in addition to those defined in the appended claims is to be included in the scope of the claims appended hereto.

The functional modules (and their corresponding instruction sequences) described thus far that enable servicing a product are, according to one alternative embodiment, imparted onto computer readable medium. Examples of such medium include, but are not limited to, random access memory, read-only memory (ROM), Compact Disk (CD) ROM, Digital Versatile Disk (DVD), floppy disks, hard disk drives and magnetic tape. This computer readable medium, which alone or in combination can constitute a stand-alone product, can be used to convert a general-purpose computing device into a device for servicing a product wherein said device is capable of servicing a product according to the techniques and teachings presented herein. Accordingly, the claims appended hereto are to include such computer readable medium imparted with such instruction sequences that enable execution of the present method and all of the teachings herein described.

Stored in the memory 240 of one example embodiment are several functional modules including a request parser 260 and a response receiver module 265. In one alternative embodiment, the product servicing apparatus 201 further includes a server module 270 which is also stored in the memory 240. A portion of the memory 240 is used to store a request table 280. A further portion of the memory 240 is used to store a response table 290. Yet another portion of the memory 240 is used to store one or more web pages, which are stored in a portion of the memory called a web page cache 295. According to one alternative embodiment, a portion of the memory 240 is used to store audio prompts in an audio prompt cache 297 and audio descriptions in an audio description cache 298. These are used in one alternative embodiment as described infra.

According to one alternative embodiment, the request receiver 205 comprises a data network interface capable of communicating with a data network 210. And according to yet another alternative embodiment, the request receiver 205 comprises a telephone circuit interface capable of interfacing with a telephone circuit 215. In one alternative embodiment, the response receiver 220 comprises a data network interface capable of communicating with a data network 225. According to yet another alternative embodiment, the data network interface is responsive to an Internet protocol address 222. According to this alternative embodiment, the Internet protocol address 222 provided to the data network interface is associated with a product notice receiver included in a product. It should be further appreciated that the response receiver 220 of yet another alternative embodiment further includes a networking card that captures data packets from a network fabric which include a destination address substantially equal to the Internet protocol address 222 provided to the response receiver 220. It should be further appreciated that the response receiver 220 of yet another alternative embodiment further includes a networking card that captures data packets from a network fabric which include a destination address substantially equal to an Internet protocol address associated with a logical web page address 223 provided to the response receiver 220.

In yet another alternative embodiment, the response receiver 220 comprises a telephone circuit interface capable of interfacing with a telephone circuit 230. It should be appreciated that the response receiver 220, according to yet another alternative embodiment, comprises a receiver for interfacing with a telephone circuit and further includes telephone company equipment that is responsive to a particular telephone number. Accordingly, this alternative embodiment of a response receiver 220 is further capable of receiving a phone number 224. Once the telephone number 224 is received, the response receiver 220 of this alternative embodiment is responsive to the telephone number so received. According to this embodiment of a product servicing apparatus 201, the phone number 224 provided to the response receiver 220 is associated with a product notice receiver included in a product.

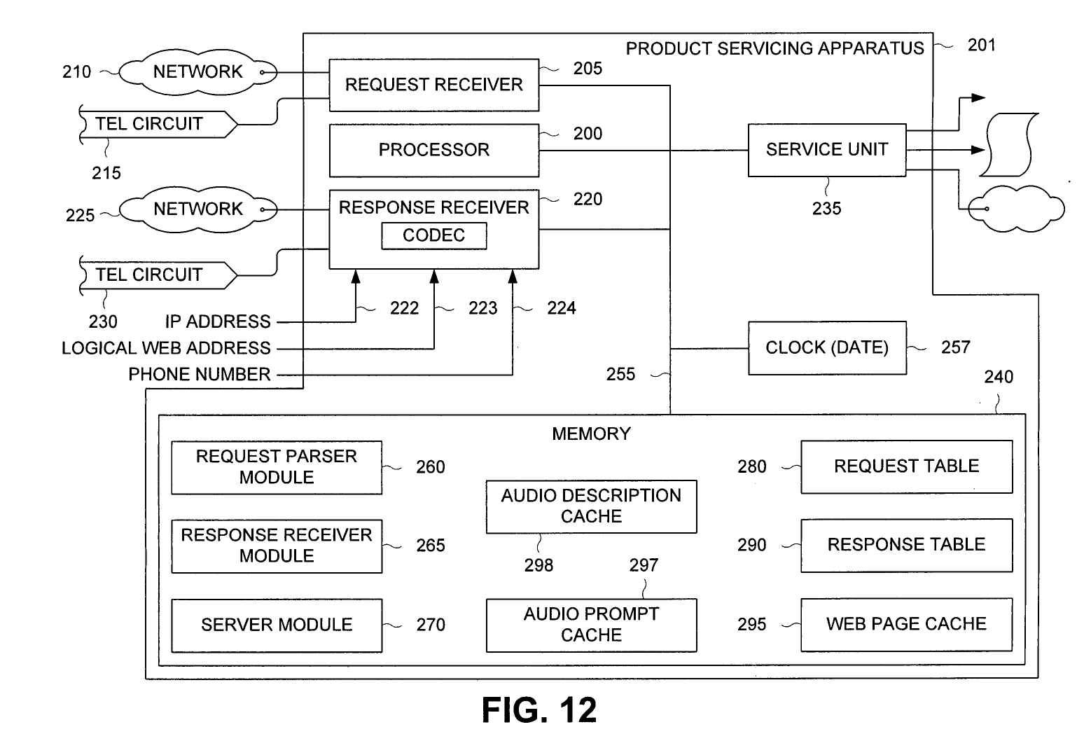

FIG. 13 is a pictorial diagram that depicts several example embodiments of a request table. According to one example embodiment, a request table 280 includes a field for tracking a record number (i.e. a record number field 300). It should be appreciated that the request table 280 need not necessarily include such a record number field 300. Other fields in the request table can be used to manage records stored in the request table. According to one alternative embodiment, a record stored in the request table 280 includes a model number field 305. The model number field 305 is used to store a model number of a product associated with a product service action. According to yet another alternative embodiment, a record stored in the request table 280 includes a serial number field 310. The serial number field 310 is used to store a serial number of a product associated with a product service action. In yet another alternative embodiment, the a record stored in request table 280 includes a lot code field 315. In yet another alternative embodiment, a record stored in the request table 280 includes a date code field 320. In either of these embodiments, the request table 280 is used to store at least one of a lot code and a date code either of which (or both collectively) correspond to a product associated with a product service action. In yet another alternative embodiment, a record stored in the request table 280 includes a target product identifier (TPID) field 325. The target product identifier field 325 is typically used to store a target product identifier for a product notice receiver included in a product that is associated with a product service action. In yet another alternative embodiment, a record stored in the request table 280 further includes a description field 330 which is typically used to store a description (e.g. a remedial action) of a product service action. According to one alternative embodiment, a description of a product service action is stored as a web page description (e.g. in a high-level description language including, but not limited to hypertext markup language a.k.a. “HTML”). According to one alternative embodiment, a record stored in the request table 280 further includes an audio prompt field 331 and an audio description field 332. It should be appreciated that the audio prompt field 331 and the audio description field 332, are used to store an audio prompt identifier and audio description identifier associated with a particular product service action request. It should be noted that a product service action is typically received by the processor 200 as it executes the request parser module 260, as described infra. It should be further noted that either of a audio prompt identifier and audio description identifier are used to select a corresponding audio prompt and audio description stored in the audio prompt cache 297 and the audio description cache 298, respectively.

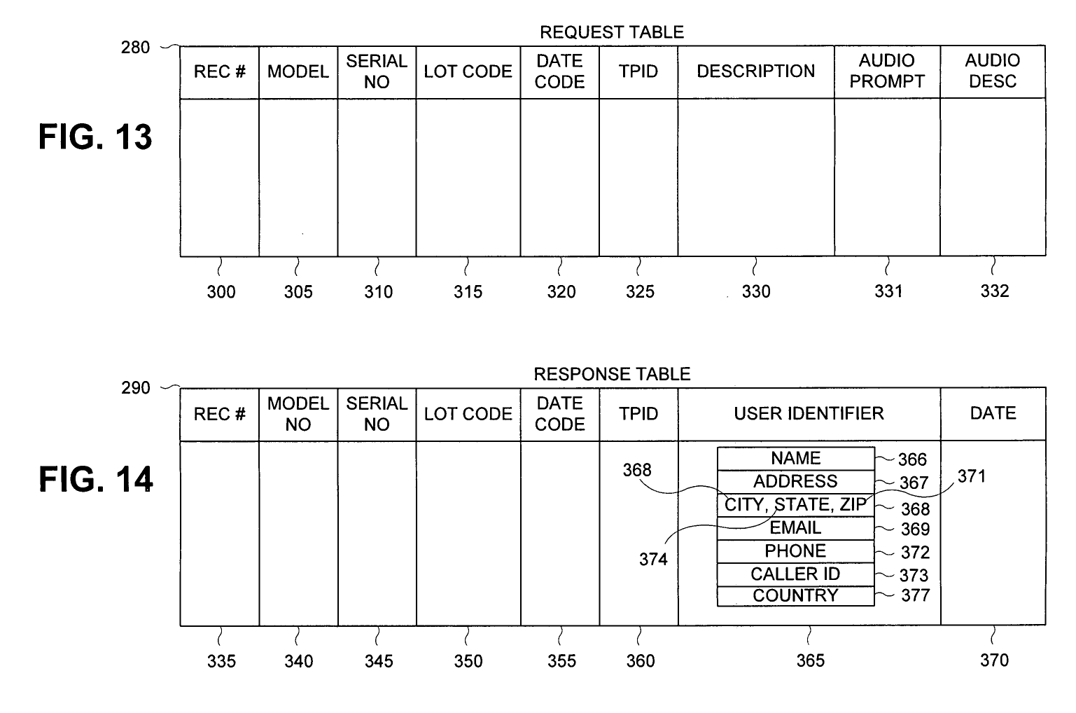

FIG. 14 is a pictorial representation that depicts several alternative embodiments of a response table. According to one alternative embodiment, a record stored in a response table 290 includes a record number field 335. Although this field is not required, one alternative embodiment of a product servicing apparatus uses the record number field 335 to manage records stored in the response table 290. In yet another alternative embodiment, a record stored in the response table 290 includes a model number field 340. The model number field 340 is used to store a model number received from a user as the user responds to a product notice signal received by a product notice receiver included in a product. In yet another alternative embodiment, a record stored in the response table 290 includes a serial number field 345. The serial number field 345 is used to store a serial number received during a user response processed in accordance with the teachings of the present method. In yet another alternative embodiment, a record stored in the response table 290 includes at least one of a lot code field 350 and a date code field 355. In either of these embodiments, the lot code field and a date code field are used, either singularly or collectively, to store any combination of a lot code and a date code or merely a lot code or merely a date code received from a user during a user response. In yet another alternative embodiment, the user response includes a target product identifier which is stored in a target product identifier field 360 included in a record stored in this alternative embodiment of a response table 290. In yet another alternative embodiment, a user identifier is stored in a user identifier field 365 included in a record stored in this alternative embodiment of response table 290. According to yet other example embodiment, the user identifier field 365 is partitioned into at least one of a name field 366, an address field 367, a city field 368, a state field 374, a zip-code field 371, a country field 377, an electronic mail address field 369, a phone field 372 and a caller identification field 373. The date upon which a user response is received is stored in a date field 370 which is included in records stored in yet another alternative embodiment of a response table 290.

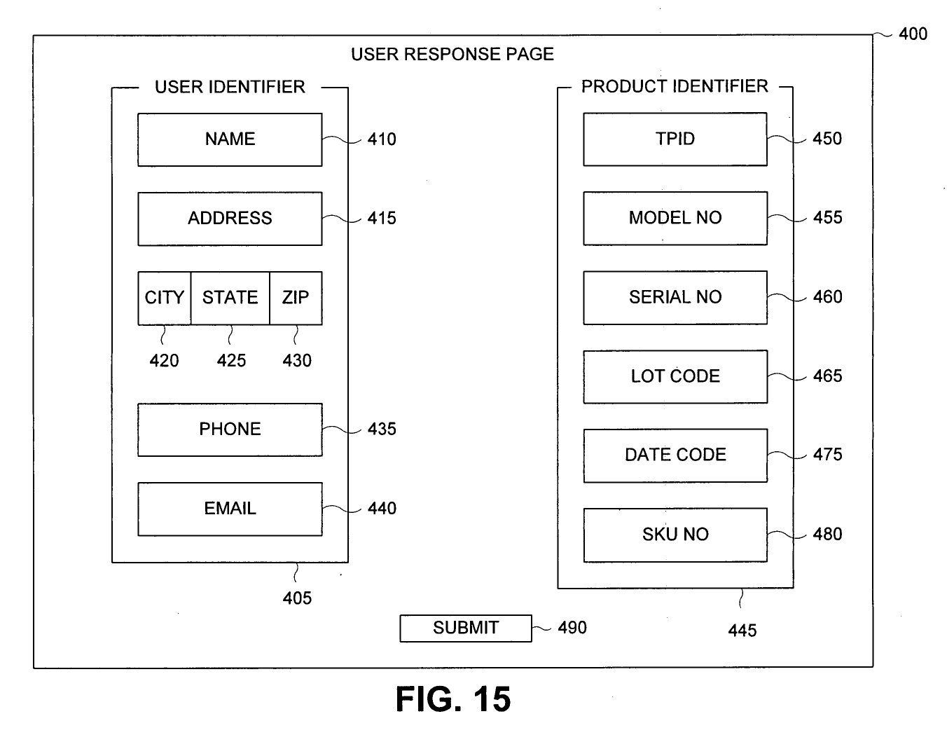

FIG. 15 is a pictorial representation that depicts several alternative embodiments of a user response web page. According to one alternative embodiment, a user response web page 400 includes a user identifier field 405 and a submit control 490. It should be appreciated that the submit control 490 can be used by a user to indicate that all data entry fields on the user response web page 400 can be accepted by the processor 200 as it executes a server module 270. According to another alternative example embodiment, the user identifier data entry field 405 includes a name data entry field 410. In yet another alternative embodiment, the user identifier data entry field 405 comprises an address data entry field 415. And in yet another alternative embodiment, the user identifier data entry field 405 comprises a city data entry field 420. And in yet another alternative embodiment, the user identifier data entry field 405 comprises a state data entry field 425. Another alternative embodiment of the user identifier data entry field 405 comprises a ZIP code data entry field 430. And in yet another alternative embodiment, the user identifier data entry field 405 comprises a country data entry field 377. In at least one alternative example embodiment, the user identifier data entry field 405 comprises a phone number data entry field 435. According to yet another alternative embodiment, the user data entry field 405 comprises an electronic mail data entry field 440. It should be appreciated that these various data entry fields can be combined in various subsets and combinations to form a user identifier data entry field 405. Other data entry fields may be included in the user identifier data entry field 405 and the examples provided herein are not intended to limit the scope of the claims appended hereto.

According to yet another alternative example embodiment of a user response web page 400, the user response web page 400 includes a product identifier data entry field 445. According to one alternative example embodiment, the product identifier data entry field 445 comprises a target product identifier (TPID) data entry field 450. In yet another alternative example embodiment, the product identifier data entry field 445 comprises a model number data entry field 455. In yet another example alternative embodiment, the product identifier data entry field 445 comprises a serial number data entry field 460. In yet another example alternative embodiment, the product identifier data entry field 445 comprises a lot code data entry field 465. In yet another alternative example embodiment, the product identifier data entry field 445 comprises a date code data entry field 475. And in yet another alternative example embodiment, the product identifier data entry field 445 comprises a stock keeping unit number data entry field 480. In operation, the user response web page 400 is directed to a client device by means of a data network 225. Typically, the processor 200 and will retrieve the user response web page 400 from the web page cache 295 stored in the memory 240 and direct the web page to the response receiver 220 which provides connectivity to the data network 225.

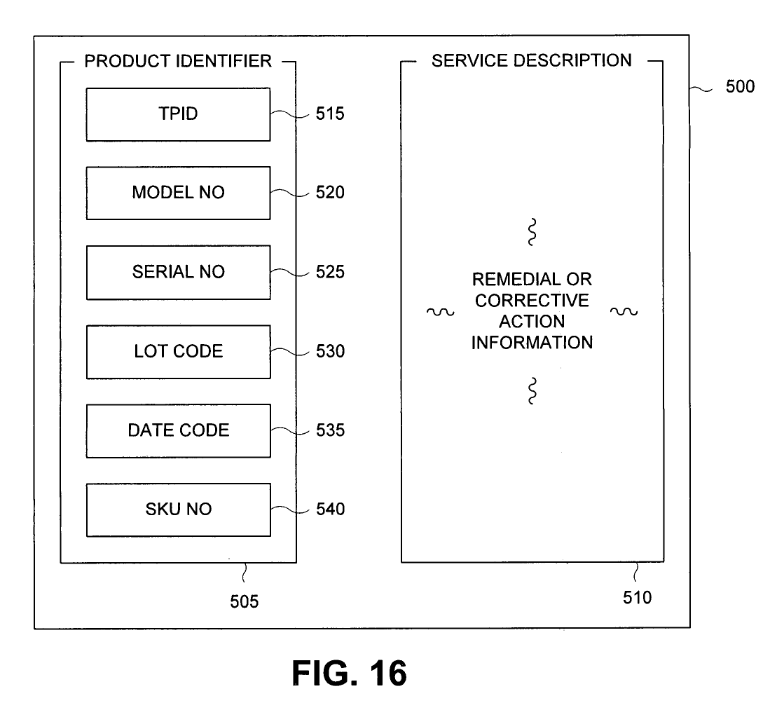

FIG. 16 is a pictorial diagram that depicts several example embodiments of a service description web page. According to one example embodiment, a service description web page 500 comprises a product identifier field 505 and a service description field 510. The product identifier field 505 includes at least one of a target product identifier field 515, a model number field 520, a serial number field 525, a lot code field 530, a date code field 535 and a stock keeping unit number field 540. It should be appreciated that once a user is presented with a user response to web page 400, as described earlier, the described embodiments will obtain a product identifier for a particular product that includes one or more of these enumerated product identifier types. As such, when the service description web page 500 is prepared prior to delivery to a client device, these enumerated product identifier fields will be populated according to a product identifier received from a user once a user response page 400 is completed by a user and accepted by a system that implements the teachings herein described. The service description field 510 provides textual and graphical remedial or corrective action information associated with a product service action.

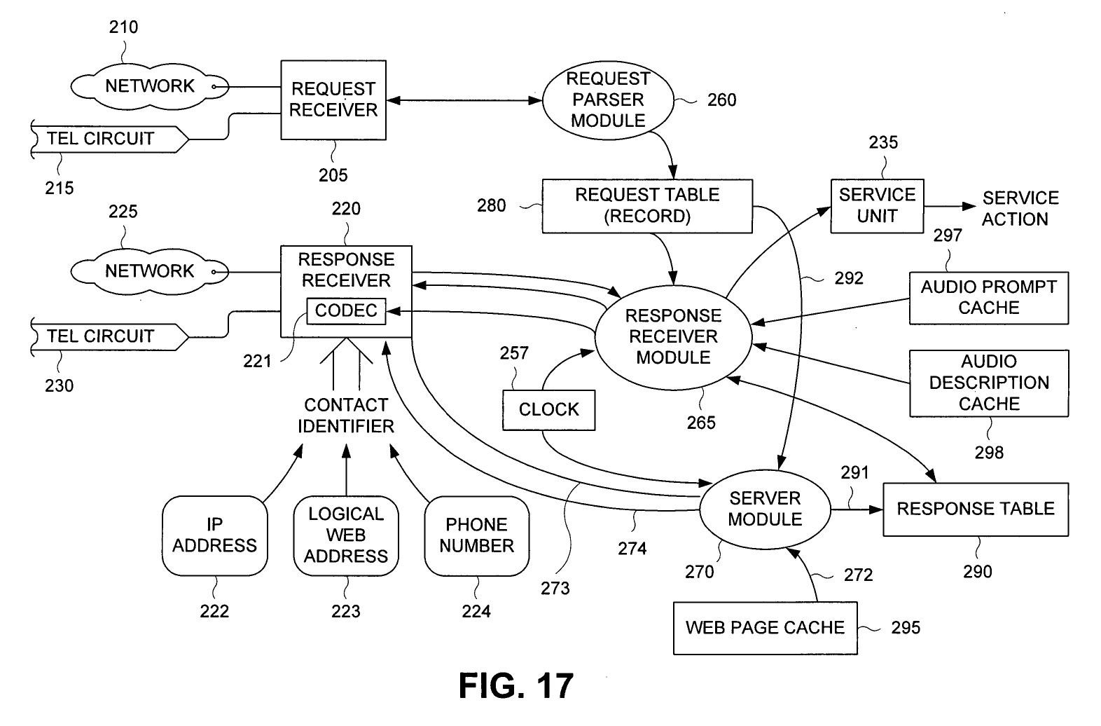

FIG. 17 is a data flow diagram that depicts the internal operation of several alternative embodiments of a product servicing apparatus. When in operation, the processor 200 executes the request parser module 260. The request parser module 260, when executed by the processor, minimally causes the processor 200 to receive a product service action request by means of the request receiver 205. The request parser module 260 further minimally causes the processor 200 to store the product service action request in the memory. According to one alternative embodiment, the request parser module 260 minimally causes the processor 200 to store the service action request in the request table 280 portion of the memory 240. According to one alternative embodiment, the request parser module causes the processor to receive a product service action request by minimally causing the processor to receive a product identifier in the form of at least one of a product model number, a product stock keeping unit number, a product serial number, a product lot code, a product date code and a product notice receiver target identifier. In addition to the product identifier, the request parser module 260 further minimally causes the processor 200 to receive a description of the product service action. Various embodiments of the request table 280, as depicted in FIG. 13, support storage of the various types of product identifiers that may be received as a product identifier for a product service action request receiver by the processor 200 from the request receiver 205 as it executes the request parser module 260. In one alternative embodiment, the request parser module further minimally causes the processor to create a product notice message (which is typically addressed to a product notice receiver included in a product that is to be serviced). In one alternative embodiment, the product notice message includes a product target identifier and the request parser module further minimally causes the processor to convey the product notice message to a distal processing center by means of the network interface (and by means of the network 225). The distal processing center will convey the product notice message to a product according to the teaching presented in the incorporated reference.

Once a product service action is received and processed by the processor 200 as it executes the request parser module 260, the processor continues by executing the response receiver module 265. When executed by the processor 200, the response receiver module 265 minimally causes the processor to receive a user response from the response receiver 220. The processor 200, in one alternative embodiment of a response receiver module, is further minimally caused to command the service unit 235 to service the user response received by the response receiver.

According to one alternative embodiment where the response receiver 220 comprises a data network interface, a cache of one or more web pages 295 is provided in the memory 240. According to one alternative embodiment, the processor 200 responds to a web page request received 273 by the response receiver 220 from a data network 225 as it executes a server module 270. The server module 270 minimally causes the processor 200 to select 272 a web page from the web page cache 295 according to the web page request received by the data network interface 220. The server module 270 further minimally causes the processor 200 to direct 274 the web page to the data network interface 220.

According to yet another alternative embodiment, the server module further minimally causes the processor to respond to a user response received by the response receiver 220 (i.e. a data network interface) by selecting 272 a user response web page from the web page cache 295. The user response web page selected according to this alternative embodiment comprises a user identifier field 405 as described supra. It should be appreciated that the server module 270 further minimally causes the processor 200 to direct the user response web page to the data network interface 220. When the user receives the user response web page 400, the user can enter a user identifier in the user identifier data entry field 405. It should be further appreciated that the user may enter various types of user identifiers into various types of user identifier data entry fields as heretofore described.

When the user actuates the submitted control 490 included in one example embodiment of a user response page 400, the server module 270 further minimally causes the processor 200 to accept from the data entry field a user identifier and store the accepted user identifier in the memory 240 (e.g. in the response table 290). It should be further appreciated that the response table 290, according to various embodiments thereof, includes a field for a user identifier 365 which is used by the processor 200 to store 291 various types of user identifiers as it continues to execute this alternative embodiment of the server module 270. According to one alternative embodiment, a product servicing apparatus 291 further includes a clock 257 which maintains a current date. In this alternative embodiment, the server module 270 further minimally causes the processor to store 291 a current date (received from the clock 257) in a data field 370 included in the response table 290. As such, the date upon which a user response is received is memorialized.

According to yet another alternative example embodiment, the server module 270 further minimally causes the processor 200 to select a user response web page 400 that includes a product identifier data entry field 445 when a user response is received by the response receiver 220. In this case, the server module 270 further minimally causes the processor 200 to direct 274 the user response web page 400 that includes a product identifier data entry field 445 to the response receiver 220. The response receiver 220 then conveys the web page to the data network 225. A user can then enter a product identifier into the product identifier data entry field 445. It should be appreciated that the product identifier entered by the user includes at least one of a target product identifier, a product model number, a product serial number, a product a lot code, a product date code, and a stock keeping unit number for the product. These various types of product identifiers can be entered by the user into the product identifier data entry field 445 in corresponding data entry fields as described supra (Cf. FIG. 15). When the user actuates the submit control 490 included in one example embodiment of a user response page 400, the server module 270 further minimally causes the processor 200 to accept from the data entry field a product identifier and store the accepted product identifier in the memory 240 (e.g. in the response table 290). It should be further appreciated that the response table 290, according to various embodiments thereof, includes various fields for different types of product identifiers which are used singularly or in various subsets and combinations by the processor 200 to store 291 various types of product identifiers as it continues to execute the server module 270. It should further be appreciated that the processor 200 stores the accepted product identifier in the same record that it stores an accepted user identifier, thereby associating one with the other.

According to yet another alternative embodiment, the server module 270 further minimally causes the processor 200 to select a service description web page 500 from the web page cache 295. According to this example alternative embodiment, the server module 270 causes the processor 200 to select 272 a service description web page 500 according to a product identifier received by the processor 200 from a user response web page 400 provided to a user. Accordingly, the selected service description web page 500 is then directed to the response receiver 220 (i.e. a data network interface). According to one alternative embodiment, the processor 200 receives a template for a service description web page from the web page cache 295. The web page template is then modified according to a service action description received 292 from the request table 280. It should be appreciated that the processor 200, as continues to execute the server module 270, will create a web page description which is then directed 274 to the response receiver 220, which in turn conveys the generated web page to the data network 225. It should be further appreciated that a complete service description web page 500 includes a remedial description 510 for a particular product service action which is retrieved from the description field 330 of the request table 280 as the processor 200 executes yet another alternative embodiment of a server module 270.

In one alternative embodiment, the response receiver 220 comprises a telephone interface circuit 230. Accordingly, a contact identifier comprises a telephone number 224. According to this alternative embodiment, the contact identifier (e.g. telephone number) is provided to the response receiver 220. In yet another alternative embodiment, the telephone circuit 230 is responsive to the contact identifier by virtue of the fact that a central telephone office directs telephone calls to the telephone circuit 230 according to the telephone number. In yet another alternative embodiment, the response receiver 220 is also capable of providing a caller identification function, which operates in conjunction with a service provided by a telephone carrier. The response receiver module 265 of this alternative embodiment, when executed by the processor, further minimally causes the processor 200 to store in the memory a caller identification provided by the response receiver 220. It should be appreciated that, according to this alternative example embodiment, the response receiver 265 causes the processor to store the caller identification in a user identifier field 365 included in a response table 290. According to one alternative embodiment, the response table 290 includes a caller identification field 373 as a separate field in the user identifier field 365. The caller identification field 373 is used by the processor 200 to store the caller identifier as it continues to execute this alternative embodiment of the response receiver module 220.

According to yet another alternative embodiment, the response receiver 220 further comprises a product identifier decoder. According to this alternative embodiment, the product identifier decoder included in the response receiver 220 receives a product identifier according to a signal received by the telephone circuit 230. The product identifier is then provided to the processor 200, which executes the response receiver module 265. The response receiver module 265 of this alternative embodiment further minimally causes the processor 200 to store in the memory 240 a product identifier provided by the response receiver 220 so as to associate the product identifier with a received caller identification. According to one example embodiment, the response receiver module 265 causes the processor 200 to store the product identifier in a response table 290, wherein each record includes a product identifier and a caller identifier field 373. It should be appreciated that, according to various embodiments, the product identifier field included in the response table 290 and managed by the processor 200 as it executes this alternative embodiment of the response receiver module 265 includes at least one of a model number field 340, a serial number field 345, a lot code field 350, a date code field 355 and a target product ID field 360.

According to yet another alternative embodiment, the response receiver 220 further comprises an audio codec 221. The audio codec 221 is capable of receiving digital information from the processor 200 and converting the digital information into audio information, which is then conveyed to telephone circuit 230. According to this example embodiment, the response receiver module 265, when executed by the processor, further minimally causes the processor 200 to direct to the codec an audio prompt from an audio prompt cache 297. It should be appreciated that the audio prompt cache 297 is typically stored in the memory. A typical audio prompt would include, but is not necessarily limited to, “please enter a product identifier”. In one alternative embodiment, the response receiver module 265 causes the processor to select an audio prompt from the audio prompt cache 297 according to a prompt identifier stored in an audio prompt field 331 included in a record stored in the request table 280.

When a user hears the provided audio prompt, the user is then able to enter a product identifier, which is received by the response receiver 220. A product identifier, according to one alternative embodiment, is received by the response receiver 200 as a series of touchtone signals. Accordingly, this alternative embodiment of a response receiver 220 includes a dual-tone multi-frequency (DTMF) decoder, which converts a series of touchtone signals into a product identifier. According to yet another alternative embodiment, the response receiver 220 uses the audio codec 221 to receive a product identifier in the form of a spoken phrase. Accordingly, this alternative embodiment of the response receiver 220 causes the codec 221 to convert the spoken phrase into a digital representation, which is conveyed to the response receiver module 265 as it is executed by the processor. This alternative embodiment of the response receiver module 265 further includes a voice-recognition module that, when executed by the processor, causes the processor 200 to convert a digital representation of a spoken phrase received from the response receiver 220 into a product identifier. The response receiver module 265 of one alternative embodiment further causes the processor 200 to receive a product identifier from the response receiver 220 and then select an audio description from the audio description cache 298 according to the received product identifier. In one alternative embodiment, the processor 200 uses the received product identifier to select a record stored in the request table 280 and retrieve from the selected record an audio description identifier (stored in an audio description field 332). The processor 200 then select an audio description from the audio description cache 298 according to the retrieved audio description identifier. The response receiver module 265 of this alternative embodiment further minimally causes the processor 200 to direct the selected audio description to the codec 221. This results in the presentation of an audio message to the telephone circuit 230. One example of an audio description includes, but is not necessarily limited to “do not use the product—return immediately to service center”. Typically, the audio information stored in either of the audio prompt cache 297 and the audio description cache 298 are stored as digitized (and optionally compressed) representation of an audio program (e.g. as a “.WAV” file).

According to one alternative embodiment, the response receiver module 265 further minimally causes the processor 200 to generate a user response according to a received user identifier, wherein the user identifier is received from the response receiver 220. It should be appreciated that a user identifier, according to one example embodiment of the response receiver module 265, is received from at least one of a data network 225 and a telephone circuit 230 in various forms as heretofore described. Such user identifier, according to one alternative embodiment, includes at least one of a name, an address, a city, a state and a zip code for a user. The generated user response is then directed to the service unit 235 in order to affect a service action for a particular product. It should be appreciated that the service unit 235, according to one alternative embodiment, comprises a printer which is used to print a service action directive. According to another alternative embodiment, the service unit 235 comprises an automatic email generating software, which is used to email a service action directive to a designated email address. Such a service action directive can then be acted upon by product service personnel. Such a service action directive, according to one alternative embodiment, comprises a mailing label that can be used to forward a product upgrade kit (or any other correspondence or package) to a user in order to affect a product service action.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

It should be appreciated that although described as an audio prompt cache 297 and an audio description cache 298, the descriptions herein provided are to include embodiments were in the audio description and an audio prompt or particular for service action product service action are stored in the request table, for example in an audio prompt field 331 and in an audio description field 332 each of which are associated with a particular record in the request table, where the record is associated with a particular product service action request.

1. (canceled)

2. (canceled)

3. A method for providing aftermarket service for a product:
receiving a request for a product service action; and
receiving a user response according to a contact identifier associated with a product centric notification capability included in the product; and
servicing the user response.

4. (canceled)

5. The method of claim 3 wherein the contact identifier comprises at least one of a logical web page address and an internet protocol address and receiving a user response comprises receiving a request for a web page.

6. The method of claim 5 further comprising providing a web page in response to the request for a web page.

7. The method of claim 5 further comprising:
providing in response to the request for a web page a web page that includes a first data entry field;
accepting a user identifier from the first data entry field; and
storing the accepted user identifier.

8. The method of claim 7 wherein the web page further comprises a second data entry field further comprising:
accepting a product identifier from the second data entry field; and
storing the product identifier in association with the user identifier.

9. The method of claim 3 wherein the contact identifier comprises a telephone number and receiving a user response comprises receiving a telephone call by means of a telephone channel.

10. The method of claim 9 further comprising:
receiving a caller identification from the telephone channel; and
storing the caller identification.

11. The method of claim 10 further comprising:
receiving a product identifier from the telephone channel; and
storing the product identifier in association with the caller identification.

12. The method of claim 3 wherein servicing the user response comprises:
providing a web page that includes a product identifier data entry field;
accepting a product identifier from the product identifier data entry field; and
providing a description web page according to the accepted product identifier.

13. (canceled)

14. The method of claim 3 wherein servicing the user response comprises:
receiving a user identifier; and
causing a product upgrade kit to be dispatched to a product user according to the received user identifier.

15. A product servicing apparatus comprising:
processor capable of executing an instruction sequence;
request receiver capable of receiving a request for a product service action;
response receiver capable of receiving a user response wherein the response receiver is responsive according to a contact identifier included on the product, wherein the contact identifier is associated with a product notice receiver included in the product;
service unit capable of servicing a user response;
memory;
one or more instruction sequences stored in the memory including:
request parser module that, when executed by the processor, minimally causes the processor to:
receive a product service action request from the request receiver; and
store the product service action in the memory;
response receiver module that, when executed by the processor, minimally causes the processor to:
receive a user response from the response receiver; and
command the service unit to service the user response.

16. (canceled)

17. The product servicing apparatus of claim 15 wherein the contact identifier comprises at least one of an internet protocol address and a logical web page address and the response receiver comprises a data network interface capable of receiving a web page request according to at least one of the internet protocol address and the logical web page address further comprising a cache of one or more web pages stored in the memory.

18. The product service apparatus of claim 17 further comprising:
server module stored in the memory that, when executed by the processor, minimally causes the processor to:
select a web page from the web page cache according to a web page request received by the data network interface;
direct the web page to the data network interface.

19. The product service apparatus of claim 17 further comprising:
server module stored in the memory that, when executed by the processor, minimally causes the processor to:
select a user response web page from the web page cache according to a web page request received by the data network interface, wherein the web page includes a user identification data entry field;
direct the user response web page to the data network interface;
accept from the user identifier data entry field a user identifier; and
store in the memory the accepted user identifier.

20. The product service apparatus of claim 19 wherein the server module when executed by the processor, further minimally causes the processor to:
select a user response web page from the web page cache according to a web page request received by the data network interface, wherein the web page includes a product identifier data entry field;
direct the user response web page to the data network interface;
accept from the data entry field a product identifier; and
store in the memory the product identifier in association with the user identifier.

21. The product service apparatus of claim 17 further comprising:
server module stored in the memory that, when executed by the processor, minimally causes the processor to:
select a service description web page from the web page cache according to a product identifier accepted by the processor from the user response web page; and
direct the selected service description web page to the data network interface.

22. The product servicing apparatus of claim 15 wherein the contact identifier comprises a telephone number and the response receiver comprises a telephone circuit capable of receiving a telephone call according to the telephone number.

23. The product servicing apparatus of claim 22 wherein the response receiver is further capable of providing a caller identification and wherein the response receiver module, when executed by the processor, further minimally causes the processor to store in the memory a caller identification provided by the response receiver.

24. The product servicing apparatus of claim 23 wherein the response receiver further comprises a product identifier decoder capable of providing a product identifier according to a signal received by means of the telephone circuit and wherein the response receiver module, when executed by the processor, further minimally causes the processor to store in the memory a product identifier provided by the response receiver wherein the storage of the product identifier is in association with the caller identification.

25. (canceled)

26. The product servicing apparatus of claim 15 wherein the response receiver module, when executed by the processor, further minimally causes the processor to:
receive a user identifier from the response receiver;
generate a user response according to the user identifier; and
direct the user response to the service unit.
